(19) United States
(12) Patent Application Publication
(10) Pub. No.: US 2025/0109533 A1
(43) Pub. Date: Apr. 3, 2025

(54) METHOD AND SYSTEM FOR CUSTOMIZED GARMENT FABRICATION USING BODY SCAN AND KNITTING MACHINE

(71) Applicant: PRJCT B CO., New York, NY (US)

(72) Inventors: Bella Baidak, New York, NY (US); Zain Abdelrazeq, Darien, CT (US)

(21) Appl. No.: 18/902,299

(22) Filed: Sep. 30, 2024

Related U.S. Application Data
(60) Provisional application No. 63/541,551, filed on Sep. 29, 2023.

(51) Int. Cl. D04B 15/66; B33Y 50/00; D04B 35/00; G06T 7/50

(52) U.S. Cl. CPC D04B 15/66; B33Y 50/00; D04B 35/00; G06T 7/50; D10B 2501/00; G06T 2200/24; G06T 2207/20084; G06T 2207/30196

(57) ABSTRACT

Methods of producing a customized garment for a subject are disclosed. The methods include acquiring a plurality of physical parameters of the subject, providing the plurality of physical parameters to an artificial neural network trained to extract measurements and define a shape analysis of the subject to produce a digital body, responsive to the extracted measurements and shape analysis, producing a custom pattern, displaying the custom pattern on the digital body, generating production instructions from the custom pattern, and directing the production instructions to a knitting machine programmed to produce at least a portion of the customized garment in accordance with the production instructions. Systems for producing a customized garment are also disclosed. The systems include a body scanner, a computing unit, and a production subsystem including a knitting machine.

### CROSS-REFERENCE TO RELATED APPLICATIONS

This application claims priority under 35 U.S.C. § 119(e) to U.S. Provisional Patent Application No. 63/541,551 titled “METHOD AND SYSTEM FOR CUSTOMIZED GARMENT FABRICATION USING BODY SCAN AND KNITTING MACHINE” filed Sep. 29, 2023, the entire disclosure of which is herein incorporated by reference in its entirety for all purposes.

### FIELD OF TECHNOLOGY

The disclosure relates to methods and systems for the production of customized garments. In particular, the disclosure relates to methods and systems for the production of customized garments from body scans using knitting machines.

### SUMMARY

In accordance with one aspect, there is provided a method of producing a customized garment for a subject. The method may comprise acquiring a plurality of physical parameters from the subject. The method may comprise providing the plurality of physical parameters to an artificial neural network trained to extract measurements and define a shape analysis of the subject to produce a digital body. The method may comprise, responsive to the extracted measurements and shape analysis, producing a custom pattern. The method may comprise displaying the custom pattern on the digital body. The method may comprise generating production instructions from the custom pattern. The method may comprise directing the production instructions to a knitting machine programmed to produce at least a portion of the customized garment in accordance with the production instructions.

In some embodiments, the plurality of physical parameters are acquired through a body scan of the subject.

In some embodiments, the method may further comprise acquiring a garment type selection from the subject and producing the custom pattern responsive to the extracted measurements, shape analysis, and the garment type selection.

In some embodiments, the method may further comprise providing at least two customization options associated with the custom pattern, acquiring a selection of at least one customization option, responsive to the selection of the at least one customization option, producing an updated custom pattern, displaying the updated custom pattern on the digital body, and generating the production instructions from the updated custom pattern.

In some embodiments, the method may further comprise generating post-knitting instructions from the custom pattern and directing the post-knitting instructions to a post-knitting subsystem programmed to produce a remaining portion of the customized garment in accordance with the post-knitting instructions.

In some embodiments, the method may further comprise displaying the digital body.

In some embodiments, the method may further comprise acquiring a rejection of the digital body from the subject, and responsive to the rejection, acquiring a new body scan of the subject.

In some embodiments, the method may further comprise storing the digital body and the custom pattern on a memory storage unit.

In some embodiments, the method may further comprise storing a plurality of digital bodies from a plurality of users and a plurality of custom patterns on a database.

In some embodiments, the method may further comprise providing at least one recommended customization option associated with the custom pattern, the at least one recommended customization option generated responsive to the plurality of custom patterns stored on the database.

In some embodiments, the at least one recommended customization option is associated with at least one similar digital body from another subject.

In some embodiments, the method may comprise directing the production instructions to an order management system operably connected to a plurality of knitting machines, the order management system programmed to direct the production instructions to an optimal knitting machine responsive to criteria selected from location of the knitting machine, capabilities of the knitting machine, and availability of materials associated with the knitting machine.

In some embodiments, the production instructions include instructions to incorporate a unique identifier in the at least a portion of the customized garment.

In accordance with another aspect, there is provided a system for producing a customized garment for a subject. The system may comprise a body scanner configured to capture a digital representation of a subject. The system may comprise a computing unit running a user interface operably connectable to the body scanner, the user interface configured to: extract measurements and generate a shape analysis of the subject from the digital representation of the subject, display a digital body produced from the extracted measurements and shape analysis, produce a custom pattern from the extracted measurements and shape analysis, display the custom pattern on the digital body, and generate production instructions from the custom pattern. The system may comprise a production subsystem operably connectable to the user interface configured to produce at least a portion of the customized garment in accordance with the production instructions.

In some embodiments, the body scanner is a camera on a smart phone.

In some embodiments, the computing unit is a smart phone or computer.

In some embodiments, the production subsystem comprises a knitting machine.

In some embodiments, the production subsystem further comprises a thermoform and/or a 3D printer.

In some embodiments, the computing unit is operably connected to a memory storage device programmed to store the digital body and the custom pattern.

In some embodiments, the memory storage device is a cloud-based memory storage.

In some embodiments, the computing unit is operably connected to a database programmed to store a plurality of digital bodies from a plurality of users and a plurality of custom patterns.

In some embodiments, the user interface is configured to provide at least one recommended customization option responsive to the plurality of custom patterns.

In some embodiments, the system comprises a network of production subsystems and an order management system operably connectable to the computing unit, the order management system programmed to direct the production instructions to an optimal production subsystem within the network of production subsystems responsive to criteria selected from location of the production subsystem, capabilities of the production subsystem, and availability of materials associated with the production subsystem.

In accordance with another aspect, there is provided a method of facilitating customized garment production for a subject. The method may comprise providing a user interface configured to extract measurements and generate a shape analysis of the subject from a digital representation of the subject, display a digital body produced from the extracted measurements and shape analysis, produce a custom pattern from the extracted measurements and shape analysis, display the custom pattern on the digital body, and generate production instructions from the custom pattern.

In some embodiments, the method may further comprise providing a knitting machine operably connectable to the user interface configured to produce at least a portion of the customized garment in accordance with the production instructions.

In accordance with another aspect, there is provided a system for producing a customized garment for a subject. The system may comprise an order management system operably connectable to a computing unit running a user interface, the user interface configured to: extract measurements and generate a shape analysis of the subject from a digital representation of the subject captured from a body scanner, produce a custom pattern from the extracted measurements and shape analysis, and generate production instructions from the custom pattern. The system may comprise a network of production subsystems operably connectable to the order management system configured to produce at least a portion of the customized garment in accordance with the production instructions. In some embodiments, the order management system is programmed to direct the production instructions to an optimal production subsystem within the network of production subsystems responsive to criteria selected from location of the production subsystem, capabilities of the production subsystem, and availability of materials associated with the production subsystem.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic drawing of a system for producing a customized garment, in accordance with one embodiment;

FIG. 2 is a schematic drawing of a system for producing a customized garment, in accordance with one embodiment;

FIG. 3 is a schematic drawing of a system for producing a customized garment, in accordance with one embodiment;

FIG. 4A is a first view of a user interface, in accordance with one embodiment;

FIG. 4B is a second view of a user interface, in accordance with one embodiment;

FIG. 4C is a third view of a user interface, in accordance with one embodiment;

FIG. 5 is a flow diagram showing a method of producing a customized garment, in accordance with one embodiment;

FIG. 6 is a flow diagram showing a method of producing a customized garment, in accordance with one embodiment

FIG. 7 is a schematic drawing of a system for producing a customized garment, in accordance with one embodiment; and

FIG. 8 is a flow diagram showing a method of producing a customized garment, in accordance with one embodiment.

### DETAILED DESCRIPTION

Traditional garment making systems and methods grapple with a range of daunting challenges. Firstly, conventional apparel production methods contend with inefficient sizing options that often neglect individual body shapes and fit preferences, leading to poorly fitting and uncomfortable apparel. This dilemma amplifies apparel return rates, incurring substantial costs for retailers and contributing to environmental strain. Secondly, the fashion industry's extensive global supply chain wrestles with inefficiencies stemming from extensive transportation and logistical intricacies, resulting in additional environmental degradation. Thirdly, mass production of apparel often yields low-quality clothing that fails to meet consumer expectations, exacerbating overconsumption and generating considerable textile waste.

Moreover, conventional garment manufacturing technology is not suitable for mass customization. Instead, conventional technology relies on standardized production of apparel, limiting the industry's ability to offer personalized options efficiently. Additionally, traditional garment production is plagued by long lead times, slowing the industry's responsiveness to shifting fashion trends and consumer demands. Lastly, any existing custom clothing options often prove time and cost-inefficient due to the reliance on manual measurements and fittings. These multifaceted challenges underscore the urgent need for innovative, sustainable, and customer-centric solutions to transform the fashion industry. Thus, there is a need for methods and systems for the production of customized garments.

The disclosure relates to systems and methods for the creation of custom-fit knit garments based on body scan data and user input. The systems disclosed herein extract measurements and shape analysis from a body scan of the user and consider fit and style preferences of the user to create knitting and fabrication instructions for a custom garment. From the knitting and fabrication instructions, the systems disclosed herein may produce custom garments with diverse sizes, structures, knit stitches, including variable stitch densities and construction techniques with different purl stitches and net structures, weave-in techniques where floats can be interlaced into knits in a weft direction, as well as, heat compression and thermoforming, and integration of 3D-printed components. The process may continue at converting knitting machine settings and equipment variation instruction data into production variation or customization instructions.

The knitting machine may produce at least a portion of the consumer selected customization garment. This results in an efficient creation of personalized garments that align with the user's body shape, fit preferences, and style choices. Additionally, the ability to apply customizations to the design further enhances the adaptability and functionality of the garments, providing a solution to the challenges of traditional garment production.

The methods disclosed herein generally include performing a body scan on an individual, extracting measurements from the body scan and extracting a shape analysis from the body scan, generating an initial custom pattern from the extracted measurements and shape analysis, selecting fit and style preferences, generating a final custom pattern including the selected fit and style preferences, and producing the garment from the final custom pattern.

The methods may be performed with a system for producing a customized garment. The system may generally include a computing unit running a user interface which provides a platform for interaction with the user. For instance, the user interface may be configured to extract measurements and shape analysis from the body scan and allow a user to provide fit and style preferences for production of the final custom pattern. The system may also include a body scanner configured to capture one or more digital representations of the user, performing the body scan and a knitting machine configured to produce the customized garment from the final custom pattern.

Thus, in accordance with one aspect, there is provided a method of producing a customized garment. To initiate the production, a user may be prompted to select a garment style. The prompt may be provided to the user through the user interface accessible on a computing unit, such as a smart phone or personal or desktop computer. The user may interact with the user interface to make the selection.

The user may select a preferred garment style from a library of pre-designed options. In certain embodiments, the user or a third party, such as a designer, may provide a garment style option. The library may optionally be created or supplemented with uploaded garment style options.

The garment style selection may act as a reference for subsequent steps and guide the customization process towards the user's preferences. The library of pre-designed options may include a variety of garments designed to be worn by the user. For instance, the library may include undergarments, tops, bottoms, footwear, or outerwear. Within each of these categories, the library may include subcategories, such as bras, underwear, shapewear, swimwear; shirts, blouses, camisoles, cardigans, vests, sweaters, dresses; pants, skirts, shorts; sneakers, sandals, boots, loafers; jackets, coats, and others. In certain embodiments, the library may include accessories, such as scarves, gloves, ear-pieces, belts, hats, eyeglasses, or handbags.

In certain embodiments, the method may include providing a recommendation for the garment type selection. For instance, the user interface may be programmed to provide a recommendation for the selection to the user. The user may be prompted to provide a description of an event, dress code, weather condition, or outfit (such as, another garment to be paired with the generated garment) for the proposed garment. The user interface may show garment type recommendations based on this input. In one exemplary embodiment, the user may describe a dress or top style as an “outfit,” and the method may provide a recommendation for bra style to be selected as the garment type based on the dress or top style described. The recommendations may be generated from historical garment type selections made by the same user or another user, optionally a plurality of users. In some embodiments, the other user or plurality of users for the garment type selection may be correlated with the current user, for example, the system may be programmed to provide recommendations from similar users.

While the disclosure generally refers to production of a customized garment, it should be noted that the methods disclosed herein may also be employed to produce custom apparel designs. The custom design may be produced from body scan data captured from the user. However, in some embodiments, the custom design may be produced from available body scan data, for example, from a library of body scan data. In some embodiments, a library of pre-defined body shapes may be made available for users to produce custom apparel designs. The pre-defined body shapes may include, for example, rectangle, inverted triangle, hourglass, pear, apple, combinations thereof, and variations thereof. In some embodiments, the library of pre-defined shapes is produced from body scan data captured from a plurality of users. For example, anonymous digital bodies may be produced from body scan data captured from users globally.

In some embodiments, the methods may comprise acquiring a body scan of the user. The user may be prompted to generate a body scan, for example, by the user interface. The request for a body scan may be made before or after the optional garment style selection. In some embodiments, a previously-acquired body scan may be used, for example, a body scan stored on a user profile of the user. In some embodiments, the user interface may prompt a user to perform periodic updates to the body scan. In some embodiments, the user interface may recommend performing a body scan each time the user desires to produce a new customized garment.

The body scan may be performed by acquiring one or more digital representations or data points from a physical profile of the user. The user may undergo a body scanning procedure, which may be performed by the camera of a smart phone or other computing device or by using a scanning device. The digital representation may be or include one or more images, such as, still images, 3D construction of images, or video that captures contours of the user's body. The digital representation may be or include a point cloud, or 3D mesh of the physical profile of the user. In some embodiments, the body scanner may utilize depth cameras, photogrammetry, lidar scanning, structured white light scanning, laser scanning, time of flight scanning, thermal scanning, millimeter wave or other radio frequency scanning, ultrasonic scanning, or other photograph or scanning technology to acquire the body scan.

In some embodiments, the user interface may recommend poses or angles for the body scan. The user interface may provide an indication of progress of the body scan, for example, indicating which sections of the body have been captured and which sections of the body are still needed to complete the scan.

The body scan may include data defining a plurality of physical parameters of the user, which correlate to the various contours and physical features of the user's body captured through the scan. In other embodiments, the plurality of physical parameters may be acquired without a body scan. The plurality of physical parameters may be acquired from the body scan, from measurements and other body data (such as a description of body shape) provided by the user, from an uploaded image of the user, or combinations thereof.

The physical parameters may be analyzed to extract precise measurements of the individual's body. For instance, the measurements may be extracted using an algorithm for measurement extraction. Using an artificial neural network trained to extract measurements, the plurality of physical features may be transformed to generate a plurality of landmarks defining measurements of the subject. The artificial neural network may also generate a probability map for the landmarks. With user feedback and by using machine learning, the artificial neural network may improve accuracy of the extracted measurements over time.

The physical parameters may also be transformed to define a shape analysis of the user. The shape analysis defines features of an optimized fit for the user. Specifically, the shape analysis may comprise an evaluation of where the most support or shaping is needed to produce a garment having an optimized fit for the user. The shape analysis may ensure that the produced garment provides both aesthetic appeal and functional comfort specific to the individual's unique body contours.

The shape analysis may be generated using an algorithm for shape analysis. Using an artificial neural network the plurality of physical parameters obtained from the body scan may be transformed to generate the shape analysis, correlating to areas where additional support or shaping may be beneficial or required. With user feedback and by using machine learning, the artificial neural network may improve accuracy of the shape analysis over time.

One or more artificial neural network described herein may optionally operate on the principal component analysis method (PCA). PCA is a statistical method employed for dimensionality reduction, data compression, and extracting crucial information from complex datasets. By transforming the initial variables, which are often highly correlated, PCA may produce a fresh set of uncorrelated variables known as principal components. These components are linear combinations of the original variables and are ordered based on the variance they capture in the data. In the context of a body scan, PCA may be used for shape analysis by diminishing the data's dimensionality while preserving essential details about the user's body shape. Thus, PCA may be used for designing customized products that conform precisely to individual body contours.

These artificial neural networks trained to generate the extracted measurements and shape analysis may be referenced against a dataset generated by other users, such as global users of the system. In some embodiments, the artificial neural networks may be referenced against existing software tools for 3D measurement extraction, such as PolyWorks™ (developed by InnovMETRIC Software Inc., Quebec City, Quebec, Canada).

While not wishing to be bound by theory, it is believed that by considering both the extracted measurements and shape analysis of the user generated from the body scan, a customized garment can be produced having an improved fit that better correlates with the precise measurements and body features of the user. Furthermore, by incorporating the subjective fit preferences of the user, the customized garment can be efficiently produced with high user satisfaction.

In some embodiments, the user may be prompted to accept or reject the displayed digital body. For instance, the user interface may include a prompt to either accept or reject the digital body. If the user accepts the digital body, the process may continue to the custom pattern production. Optionally, the accepted digital body may be stored on a memory storage. If the user rejects the digital body, the user may be prompted to perform a new body scan. The process may be repeated by extracting measurements and producing a shape analysis from the physical parameters of the new body scan to generate a new digital body.

The methods may include producing a custom pattern with the extracted measurements and shape analysis. The system may be programmed to automatically adjust parameters of a stored generic pattern to generate the personalized pattern for the user. For instance, the system may be programmed to independently scale features of a generic pattern up or down to generate the personalized pattern. Thus, the custom pattern is a personalized pattern specific to the user's body measurements and contours. If the user selected a garment type at the outset, the custom pattern may correlate with the selected garment type. The system may store a variety of generic patterns, for example, one or more generic pattern for each garment type option provided to the user.

The produced custom pattern may be displayed to the user on the digital body, for example, via the user interface. The generated custom pattern may be superimposed onto the user's digital body to create a virtual display. The user may have the ability to rotate the virtual display and zoom in on certain features, viewing the custom pattern as it rests on the realistic digital body from all angles. The simulation may be used to aid the user in accepting or rejecting the custom pattern, and optionally, make design optimization decisions. The simulation may be generated by software such as 3D Virtual Prototyping (Optitex, New York, NY), VStitcher (Browzwear Solutions Pte. Ltd., Singapore), and Deviron LLC (Ithaca, NY).

The user may be prompted to select one or more customization option for the custom pattern. For instance, the software may provide at least two customization options associated with the custom pattern for selection by the user. A variety of customization options may be stored in a library, for example, a variety of customization options for each garment type. Through the user interface, the user may make a selection for the customization option.

The customization options may include fit and/or style options, such as coverage, length, sleeve type, neckline, ease (e.g., a fitted, standard, or oversized silhouette), support (e.g., lift), color, pattern, and other design aspects, customizing the garment to their liking. The customization option may be applied to a portion of the garment or the full garment. The customization option may include the addition of post-knitting features, such as application of buttons, wires, collars, laces, bows, ties, buckles, etc.

The custom pattern may be updated responsive to the selection of the customization option, and the updated custom pattern may be displayed on the digital body. After the person indicates their fit and style preferences, the simulation of the garment may change in real time on the user's digital body, as shown through the user interface. Thus, upon receiving customization options, such as fit and style preferences, the virtual custom pattern may automatically adjust to accurately reflect the desired modifications. This dynamic visualization may assist the user in finalizing their choices before the fabrication process begins. Additionally, the selection of customization options and update to the visualized custom pattern may be repeated as many times as necessary until the user feels satisfied with their selection(s).

In certain embodiments, the method may include providing a recommendation for the customization, for example, fit or style preference. For instance, the user interface may be programmed to provide a recommendation for the selection to the user. The user may have been prompted to provide a variety of general style preferences through the user interface. The general style preferences may have been provided through a “style quiz.” The user interface may show fit and style recommendations based on this input.

The recommendations may be generated from historical fit and style selections made by the same user or another user, optionally a plurality of users. In some embodiments, the other user or plurality of users may be correlated with the current user, for example, the system may be programmed to provide recommendations from similar users. In some embodiments, the system may store a variety of fit and style recommendations provided by a stylist.

Certain customizations or patterns may not be physically capable of production, for example, due to machine-specific limitations. If a user selects style and fit preferences that result in a stitch count that exceeds the capacity of the target knitting machine, the user interface may be programmed to automatically adjust stitch count to the closest odd or even number required by the knitting machine while still accommodating the customization options as closely as possible. In certain embodiments, for example, when the customization option cannot be closely matched, the user interface may notify the user of such a limitation and prompt the user to make a different selection.

Once the user approves the custom pattern, including any customization options, and places the order for shipment or delivery of the garment, production instructions may be generated from the custom patter. Thus, the method may include generating production instructions from the custom pattern. The production instructions may be generated from an initial custom pattern or an updated custom pattern, for example, a custom pattern designed with one or more customization option. The production instructions may be directed to one or more production systems to produce at least a portion of the garment in accordance with the production instructions.

The production instructions may be assigned a unique identifier that correlates to the user's specific order. To ensure the order is tracked from design through each production step to shipment or delivery, the unique identifier may be correlated to the custom garment. In certain embodiments, the unique identifier may be attached or embedded in the garment during production. The unique identifier may include a customer identification portion. The unique identifier may include an order identification portion.

Optionally, the production instructions may be sent to queue in an order management system. The order management system may include a control center that is operably connected to a network of knitting machines and/or other production machines. The knitting machines may be located at different geographic locations or, optionally, the knitting machines may have different capabilities. The order management system may be programmed to assign the production instructions to an optimal knitting machine in the network based on certain inputs, including the delivery location of the order, the machine type required to fabricate the garment or the portion of the garment, the yarn or other materials required for production, the machine capabilities, such as the setup options, and others.

Once the knitting machine receives the production instructions, the order (as identified by the unique identifier) may be queued up on the machine. The status of the order in the order management system may be updated from unfulfilled to queued on machine. The methods may include notifying the user of the updated status of the order, for example, via an e-commerce platform or through an email or other similar method.

The production instructions may be directed to a knitting machine to produce at least a portion of the garment. Any knitting machine capable of receiving production instructions may be used. Optionally, the production instructions may be sent to an optimal knitting machine as identified by the order management system. The knitting machine may be a computerized knitting machine. One exemplary knitting machine that may be used is a v-bed machine. V-bed machines typically contain a front and back set of needles and a carriage that reciprocates back and forth. Another exemplary knitting machine is an automated or digital flat-bed knitting machine.

The knitting machine may receive the production instructions and proceed to fabricate the garment, for example, in a layer-by-layer production process. The precision afforded by such knitting machines may ensure the accurate realization of the customized pattern and fit, resulting in a high-quality garment.

Leveraging computation knitting techniques, in some embodiments, the production instructions may include stitch counts, course and wales specifications, and/or other details required for the knitting process, such as, for example, options for variable stitch densities, purl stitches and net structures, or weave-in techniques where floats can be interlaced into knits in a weft direction. These instructions provide guidance to the machine, ensuring the creation of the customized garment with utmost accuracy. For enhanced customized support, determined by the user's body shape and fit preferences, the knitting instructions can incorporate various knit stitching techniques or even incorporate double stitching, double layered knitting, double bed knitting, and weaving methods. Variable knitting techniques may be incorporated, for example, in locations where the garment requires more or less support, in accordance with the shape analysis and/or style preferences. Thus, knitting specifications are generated automatically from the user's extracted measurements, shape analysis, and style preferences to produce a custom fit knit garment.

After knitting at least a portion of the garment, the method may include making post-knitting modifications to the garment. These modifications may include techniques such as heat compression or thermoforming, also referred to as “thermal molding” herein, to add additional structure to the garment's fit, or the integration of non-knit components, including buttons or other fabric components, optionally 3D printed components to introduce functional, such as supportive or health-centric features, functional components, such as sensors, or decorative elements.

Thus, in some embodiments, production instructions may also be directed to a thermoforming, 3D printer (for example, a plastic or metal 3D printer), or other system to produce at least a portion of the garment or incorporate additional features into the knit portion of the garment. Thus, in certain instances, the production of the garment may be fully automated from the production instructions. In other embodiments, minimal manual production may be performed after at least a portion of the garment is produced. For example, final stitching and/or attachment of additional features for design or functional purposes, may be performed manually.

Thermoforming or thermal molding generally includes steaming or ironing specific parts of the knit garment on a flatbed machine. Post-knitting modifications may also include final stitches to provide structural features, such as ruching or provisions for pockets, or other slot structures to insert and attach physical components, such as 3D printed components or other functional components, e.g., sensors. An example of this concept is the integration of a 3D printed underwire into a bra design, integration of sensors into a monitoring garment, or integration of heaters into a cold-weather garment, optionally also including a battery or power source. In some embodiments, the production of such components may be automated. In some embodiments, the integration of such components may be automated. In other embodiments, the integration of such components may be manual.

Thus, in some embodiments, the method may include generating post-knitting instructions from the custom pattern. In certain embodiments, the production instructions may include such post-knitting instructions. The post-knitting instructions may be directed to systems programmed to make any adjustments to the knit garment, for example, systems programmed to produce a remaining portion of the customized garment in accordance with the post-knitting instructions. Post-knitting adjustments may include, for example, thermoforming portions of the knit garment, producing 3D printed plastic or metal components of the garment, attaching 3D printed plastic or metal components or other functional components, attaching or producing pockets, or performing final stitches to the knit garment.

In some embodiments, unique identifiers may be manually or automatically attached to or embedded in the knit garment. The unique identifier may be incorporated by several methods, including but not limited to printing the unique identifier (e.g., alphanumeric code) on the garment or attaching a tag to the garment having the unique identifier, incorporating a barcode, QR code, or other readable code identifier (optionally on a tag or directly printed on the garment during or after knitting), incorporating a radio frequency identification (ID) code, or other scannable code, (optionally within a tag or directly embedded in the fabric during or after knitting), or combinations thereof. The tags, e.g., RFID tags, may include, for example, flexible, washable, tags or threads, e.g., RFID threads. The knitting or other production machine may be configured to insert or attach tags at specific points in the product, which may be possible by modifying the machine to feed tags or threads into the fabric or attach tags at various points. Thus, in certain embodiments, the production instructions may include instructions to incorporate a unique identifier into the garment.

Tracking systems, such as barcode or RFID tracking systems, may be used to track the exact location and status of each item to control data flow, real-time visibility, and accurate tracking of each garment as it moves from a digital order to a physical item ready for delivery. Each unique identifier may be automatically associated with the corresponding order in the order management system.

After a finished garment is produced, the methods may comprise notifying the user of the finished status of the garment. The finished garment may be manually or automatically conveyed to a quality control area, where the garment may be manually or automatically inspected for any defects. Upon passing the inspection, the finished garment may be manually or automatically conveyed to an order matching area. The shipping documents including the finished garment weight and the unique identifier may be manually or automatically generated and printed. The printed shipping documents may be manually or automatically conveyed to the order matching area with any garment packing materials, where they may be matched with the finished garment by the unique identifier and packaged. The finished garment package may be manually or automatically conveyed to a shipping staging area for delivery or pickup.

In certain embodiments, the finished garment may be packaged for sale. For instance, the finished garment may be folded using an automatic folding device and/or may be wrapped and placed in, for example, a packing box automatically using an automated packing device or manually. The user may be notified about the garment being ready for shipping or pickup, and optionally provided an expected delivery date.

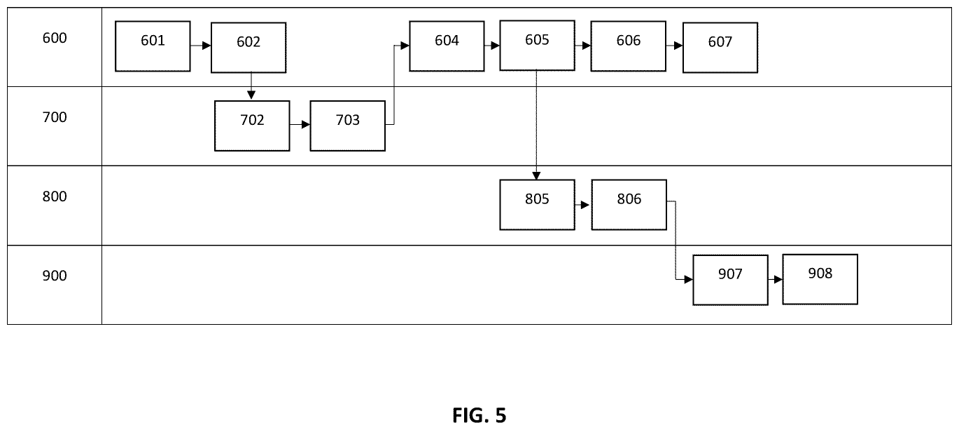

FIG. 5 is a systems map of the method workflow. As shown in the exemplary embodiment of FIG. 5, the workflow may be divided into four processes. In a first process, the customer e-commerce experience 600, the user may interact with the user interface. Specifically, the user may select the style of garment 601, which may include a prompt from an AI tool and then the user may complete a body scan 602. The method may then move into the scanning technology process 700, in which data and measurements are extracted from the body scan 702 and a shape analysis of the body scan is completed for optimized fit 703. The method may return to the customer e-commerce experience 600 where the user views a simulation of the garment on the digital body 604 and selects fit and style preferences 605, which get reflected on the digital body in real time. The method then moves into the knitting technology process 800, where stich count and course and wales for the custom pattern are generated 805 and knitting instructions are generated for the knitting machine 806. The method may then move into the production process 900, where the garment is fabricated on the knitting machine 907 and post-knitting enhancements are made 908, including thermoforming or incorporating structural or functional features. Back in the customer e-commerce experience 600, a user profile is created 606 in which the user can access previous designs, body scans, and data, and the user is able to view a virtual closet of purchases and previous designs 607, with the option to convert designs into NFTs.

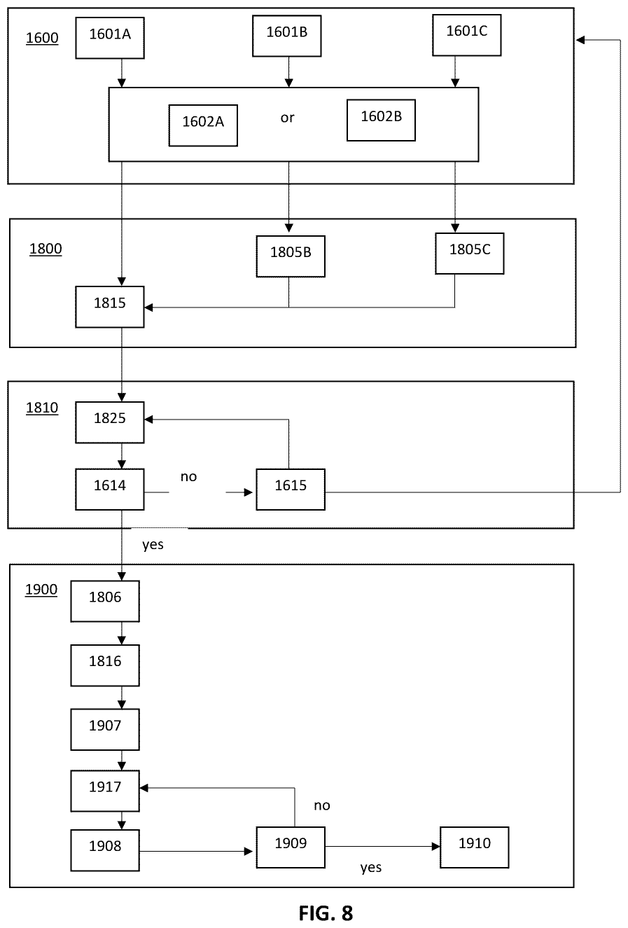

FIG. 8 is another systems map of the method workflow. As shown in the exemplary embodiment of FIG. 8, In a first process, input may be obtained from the user 1600 to select a garment by one or more of the following: the user selects a style from a library of predefined garments 1601A; the user provides data about a selection in the form of a text prompt, reference image, or by completing a questionnaire 1601B; or the user uploads a garment pattern, e.g., in knitting bitmap format or 3D model of the garment 1601C. Within the input process 1600, a digital representation of the user may be created under one or more of the following: the user may perform a body scan on a body scanner 1602A or the user may upload body measurements, body shape information, and/or an image of their body, to create a digital body 1602B. In certain embodiments, the user may opt to use a stored digital body.

In a custom knitting map generation process 1800, a knitting map may be created based on the user's provided data 1805B, or the provided garment pattern may be converted into a knitting map 1805C. A knitting map may be sized based on the body scan or digital body data 1815. For example, columns and rows may be added or subtracted from the knitting map (e.g., a bitmap) selected by the user to match the customer's body size and shape. In a garment fit and simulation process 1810, the knitting map or bitmap may be converted into a 3D mesh 1825. A physics analysis may be applied to ensure that a garment produced according to the 3D mesh is capable of being produced by a knitting machine.

The garment may be displayed on the digital body 1614. The physics analysis may enable the simulation to show how the garment will interact with the body. If the garment displayed on the digital body is approved (YES) the process moves on to production 1900. If the garment displayed on the digital body is not approved (NO) the customer may be allowed to adjust the garment fit through the user interface 1615 and optionally make an adjustment and return to the display of the digital body 1614 or return to the input process 1600.

In the production process 1900, production instructions may be generated and the order may be sent to queue in an order management system 1806. The order may be assigned to a knitting machine in the network based on one or more criteria, such as the delivery location, the machine type, the machine set up, and availability of yarn 1816. The order may be queued on the knitting machine and a status of the order may be changed to “in progress” 1907. The garment may be fabricated 1917, optionally with a unique identifier attached to the garment that matches the garment to the order. Post-production modifications may be added to the product 1908. Quality control of the produced garment may be performed by reviewing the produced garment for any production errors 1909. If the garment is approved (YES), the garment may move on to packaging and shipping to the user 1910. If the garment is not approved (NO) the garment may be returned to fabrication 1917 for correction.

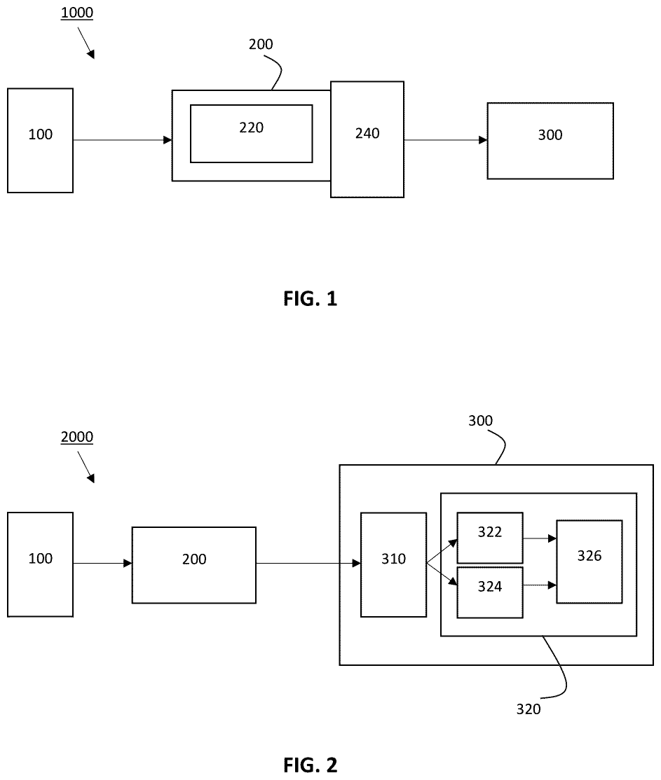

In accordance with certain embodiments, there is provided a system for production of a customized garment. One exemplary system 1000 is shown in the diagram of FIG. 1. The system 1000 may be designed to perform the methods described herein. The system 1000 may include a body scanner 100, a computing unit 200 running a user interface 220, and a production subsystem 300.

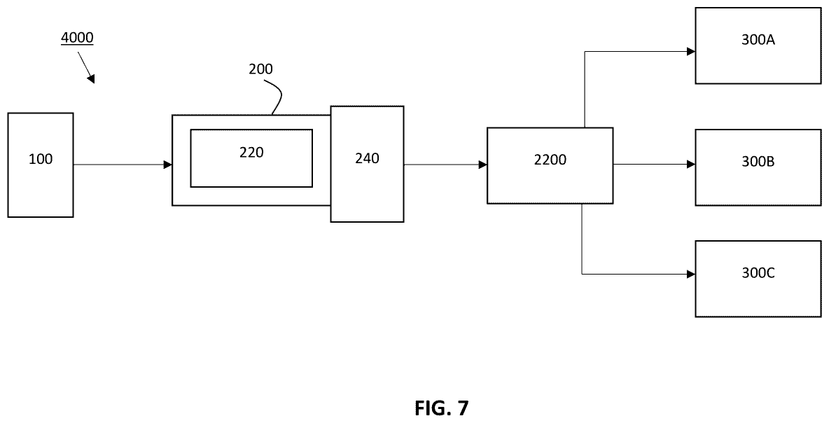

Another exemplary system is shown in FIG. 7. The system 4000 of FIG. 7 includes an order management system 2200 operably connected to a plurality of production subsystems 300A, 300B, 300C. The order management system 2200 may be configured to receive production instructions from the computing unit 200 running the user interface 220 and assign the production instructions to a specific production subsystem selected from the network of 300A, 300B, and 300C based on certain criteria, such as location of the production subsystem, capabilities of the production subsystem (including the ability of the production subsystem to produce a certain garment type and/or length of the queue at the production subsystem), and availability of materials.

The body scanner 100 may be a device configured to capture one or more digital representation of a subject or data correlating to the physical contours of the subject, optionally an image, 3D construction of images, video, point cloud, or 3D mesh of the subject. The body scanner 100 may be any device that is capable of capturing body surface data. The body scanner 100 may further be capable of representing the captured body surface data in a digital format. The digital format may, for example, comprise points in an XYZ coordinating system, polygonal mesh, non-uniform rational b-spline surfaces, or wire-frames, which can be used in a 3D computer system.

Thus, in some embodiments, the body scanner 100 may be or comprise a camera. In certain embodiments, the body scanner 100 may be a camera of a smart phone, optionally a plurality of cameras of a smart phone. Thus, a user may be able to perform a body scan with their smart phone. In some embodiments, the body scanner 100 may comprise depth cameras, a photogrammetry sensor, lidar scanner, structured white light scanner, laser scanner, time of flight scanner, thermal scanner, millimeter wave or other radio frequency scanner, ultrasonic scanner, or other photograph or scanning device capable of acquiring the body scan.

The body scanner 100 may be operably connectable to a computing unit 200 running a user interface 220. The computing unit 200 may be a smart phone, for example, the user interface may be an application downloadable to a smart phone. In some embodiments, the computing unit 200 may be a computer. The user interface 220 may be an application or program downloadable to the computer. In other embodiments, the user interface 220 may be accessed through a smart phone or computer internet browser.

The user interface 220 may be programmed to execute the methods described herein. For instance, the user interface 220 may be programmed to facilitate interaction between the system and the user, for example, by displaying garment type options, customization options, and the digital body. The user interface 220 may display recommendations to the user. The user interface 220 may receive selections from the user, such as a selection for garment type, customization option, or the acceptance or rejection of the digital body or custom pattern. The user may interact with the custom pattern, as displayed on the digital body, through the user interface 220, for example, viewing the custom pattern and digital body from different angles and visualizing real time changes to the custom pattern.

The user interface 220 may execute the algorithms of the method. For instance, the user interface 220 may be programmed to receive the body scan and physical parameters. The user interface 220 may be programmed to extract measurements and generate the shape analysis from the physical parameters. The user interface 220 may be programmed to produce the custom pattern from the extracted measurements and shape analysis, optionally further from the garment type selection and selection of customization options. The user interface 220 may be programmed to receive and/or generate recommendations to the user. The user interface 220 may additionally be programmed to generate production instructions and direct the production instructions to production subsystem 300. Thus, the user interface 220 may execute functions, such as an artificial neural network, to transform received information, such as the body scan and selections from the user, into the digital body and custom pattern.

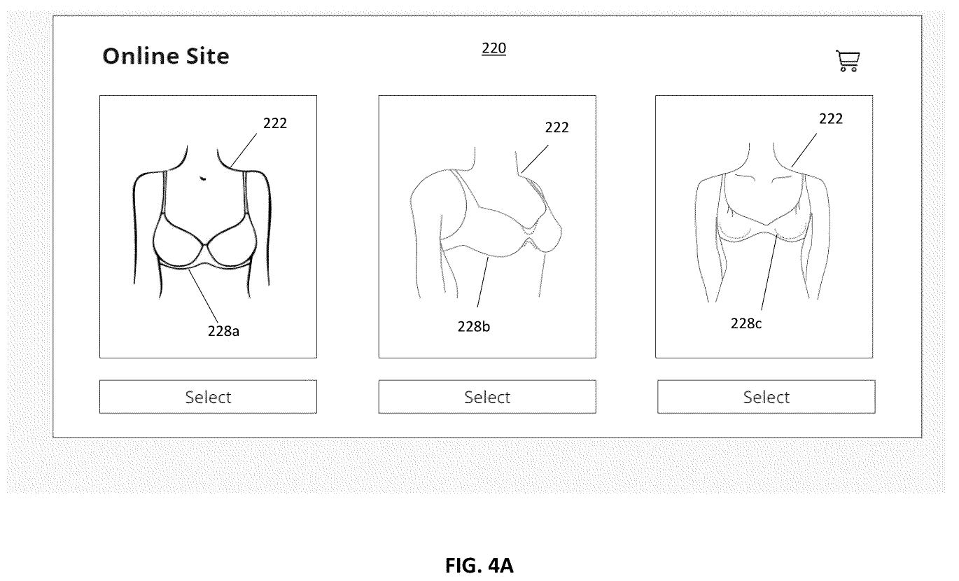

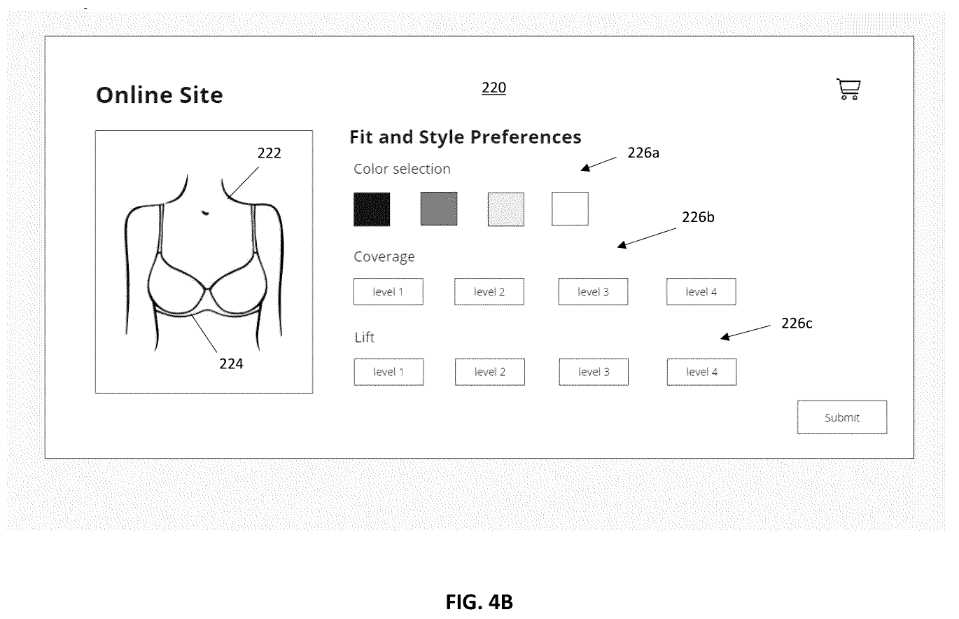

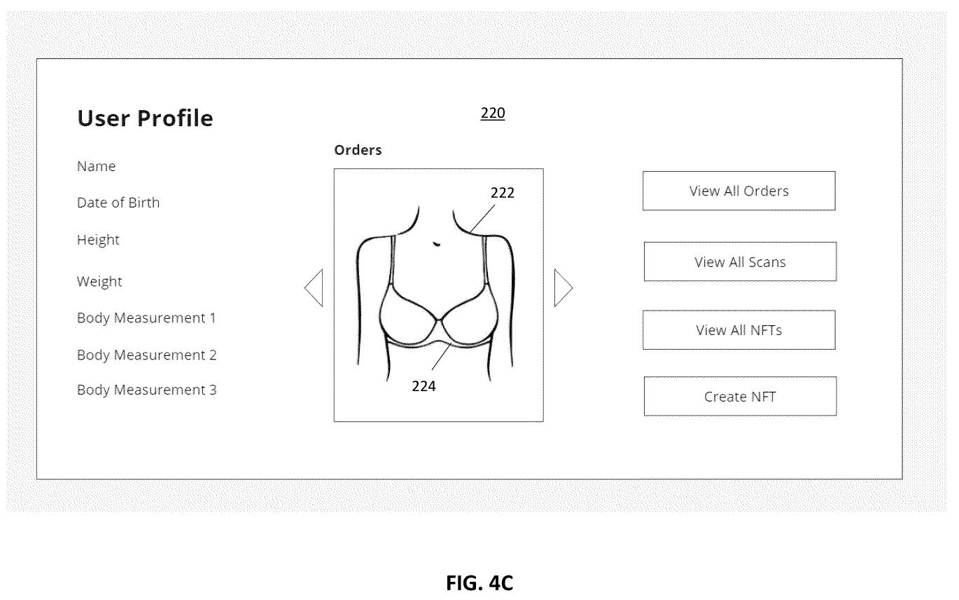

Exemplary views of the user interface 220 are shown in FIGS. 4A-4C. As shown in FIG. 4A, the user interface 220 may be programmed to receive selections from the user for garment type 228a, 228b, 228c. As shown in FIG. 4B, in another screen, the user interface 220 may be programmed to receive selections from the user for customization options, such as garment color 226a and fit and style preferences 226b, 226c (displayed as coverage options and lift options). As shown in FIG. 4C, the user interface 220 may be programmed to display user data stored on a database in a user profile. In each of the exemplary views of FIGS. 4A-4C, the user interface 220 is programmed to show custom patterns 224 on a digital body 222 displayed through the user interface 220.

The software for the user interface 220 may be stored directly on the computing unit 200, for example, as a downloadable program. In other embodiments, the software for the user interface 220 may be stored in a remote server or on the cloud, accessible through an application of computer browser connected to the internet. In yet other embodiments, certain aspects of the user interface 220 may be locally-stored and certain aspects of the user interface 220 may be stored remotely on a server or the cloud.

The user interface 220 may be operably connected to a memory storage unit 240. The memory storage unit 240 may store a library of garment types, and optionally a library of generic patterns, each generic pattern associated with a garment type. The memory storage unit 240 may store a library of garment customization options. The garment customization options may be correlated to the garment type. For instance, each garment type may be associated with a set or subset of customization options. The library options stored on the memory storage unit 240 may be tagged by dress code, outfit style, weather condition, or event. The user interface 220 may pull from these libraries when providing options to the user.

In certain embodiments, the user interface 220 may allow the creation of a user profile (FIG. 4C). Through the user profile, a user can access previous designs, scans, and data about their digital body, such as shape and measurements, size recommendations, and, optionally, changes to their bodies change over time. Users may also see a closet of past purchases. In certain embodiments, users may be able to save their digital body or custom clothing as a non-fungible token (NFT). Thus, users may be able to create libraries of custom-designed NFTs, preserving their digital bodies, creations, and/or style evolution. In certain embodiments, the saved changes to a digital body over time may be used for medical or healthcare purposes, such as, to aid in making a medical diagnosis or to provide a high-accuracy reference in a future reconstructive procedure.

Thus, the memory storage unit 240 may store personal data in association with the user profile. The personal data may include body scan data, such as a digital body, for example, a most current digital body. In certain embodiments, the personal data may include previous digital bodies. The personal data may include selected garment types. The personal data may include selected customization options, for example, preferences for customization options. The personal data may include created custom patterns, such as finalized custom patterns accepted after viewing customization options. The personal data may also include placed orders, such as finalized custom patterns from which the production instructions were sent to the production subsystem.

The memory storage unit 240 may be a local memory storage unit. In other embodiments, the memory storage unit 240 may be remote, for example, a remote server or the cloud. In yet other embodiments, the system may comprise a local memory storage unit and a remote memory storage unit. Certain data may be stored locally for fast and offline access, while other data may be stored remotely where the data storage capacity is generally greater.

In some embodiments, a database storing a plurality of digital bodies, garment type selections, selected customization options, and custom patterns may be created. The database may store data from a plurality of users, for example, the database may store data from users worldwide. In certain embodiments, the database may be limited to data authorized to be stored by the user. The data may optionally be stored anonymously, for example, data may be shared and/or stored without any user-identifying features. In some embodiments, digital body data may be stored with generic features to prevent user-identification.

Recommendations for garment type and customization options may be generated and provided from the database. The database may be stored on a server or cloud-based memory storage. In some embodiments, similar digital bodies and/or similar preferences may be correlated in the database to provide recommendations. In some embodiments, data from the database may be made accessible to third parties, such as clothing manufacturers, clothing distributors, or advertisers. Such data may be shared anonymously. In certain embodiments, shared data may be limited to data authorized to be shared by the user. Thus, the user may be prompted to select whether to opt-in to any data storage and/or sharing through the database. In other embodiments, no data from the user is shared with third parties.

The user interface may be operably connected to a production subsystem 300. The production subsystem 300 may comprise one or more production unit programmed to produce at least a portion of the garment in accordance with production instructions received from the user interface. In certain embodiments, the production subsystem 300 may comprise a knitting machine 310 (FIG. 2), such as a computerized knitting machine. The knitting machine 310 may be positioned to produce an initial portion of the garment. The knitted garment when completed may be conveyed through a finished knitted garment outlet of the knitting machine.

The production subsystem 300 may comprise a post-knitting unit 320, as shown in the exemplary system 2000 of FIG. 2. The post-knitting unit 320 may be positioned to produce one or more modification to the knit garment. For instance, the post-knitting unit 320 may be positioned downstream from the knitting machine 310, e.g., downstream from the finished garment outlet of the knitting machine 310. In certain embodiments, the post-knitting unit 320 may be or comprise a thermoform 322. The thermoform 322 may be positioned to receive the knit garment and thermally-mold one or more component of the knit garment to produce the customized garment.

In certain embodiments, the post-knitting unit 320 may be or comprise a 3D printer 324. The 3D printer 324 may be configured to produce a structural or functional 3D printed component, such as a plastic or metal component. The system 2000 may further include an integration unit 326 configured to attach 3D printed components or other features, such as pockets or functional features, such as sensors. The integration unit 326 may make final stitches to complete the customized garment. The integration unit 326 may be positioned downstream from the thermoform 322, when present, or 3D printer 324, when present.

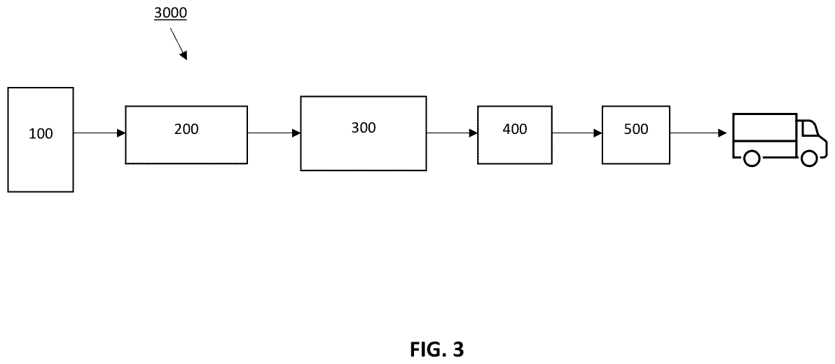

The system may further comprise a quality control subsystem 400, as shown in system 3000 of FIG. 3. The quality control subsystem 400 may be positioned downstream from the production subsystem 300. The quality control subsystem 400 may inspect the produced garment for defects.

The system 3000 may further comprise an order packing subsystem 500. The order packing subsystem 500 may be positioned downstream from the quality control subsystem 400. The order packing subsystem 500 may be configured to package the garment for shipping or sale. The order packing subsystem 500 may optionally be configured to generate a shipping label. Thus, in some embodiments, the order packing subsystem 500 may include a scale and a label printer. In some embodiments, the order packing subsystem 500 may be configured to fold and wrap the finished garment. Thus, in some embodiments, the order packing subsystem 500 may comprise a folding device, e.g., automatic folding device, and a wrapping device, e.g., automatic wrapping device. The order packing subsystem 500 may be configured to convey the packaged garment to a shipping area for delivery or pickup.

In certain embodiments, methods of facilitating custom garment fabrication are described herein. The methods may include providing a computing unit running a user interface operably connectable to a body scanner. For instance, the methods may include making the user interface downloadable by a user. The methods may include programming and/or developing the user interface, as described herein.

The methods may include providing one or more unit of a production subsystem operably connectable to the user interface. For instance, the methods may include providing a knitting machine operably connectable to the user interface. Thus, the methods may include programming or developing the user interface to be compatible with a knitting machine. In certain embodiments, the methods may include providing a thermoform, 3D printer, or other post-production unit. The methods may optionally include providing a body scanner operably connectable to the user interface. The methods may include programming or developing the user interface to be compatible with the body scanner.

In accordance with another aspect, there is provided a non-transitory computer-readable medium. The non-transitory computer-readable medium may generally have computer-readable signals stored thereon that define instruction, that, as a result of being executed by the computing unit, instruct the computing unit to perform the methods of producing a customized garment disclosed herein.

Thus, the non-transitory computer-readable medium may instruct the computing unit to perform methods comprising acts of acquiring a body scan, extracting measurements and defining a shape analysis of the subject from the body scan to produce a digital body, producing a custom pattern from a generic pattern using the extracted measurements and shape analysis, and displaying the custom pattern on the digital body. The non-transitory computer-readable medium may instruct the computing unit to perform methods comprising acts of providing at least two customization options associated with the custom pattern to the user and acquiring a selection of at least one customization option from the user, the custom pattern being produced using the extracted measurements, shape analysis, and selection of at least one customization option. The non-transitory computer-readable medium may instruct the computing unit to perform methods comprising acts of generating production instructions from the custom pattern and directing the production instructions to a knitting machine, as previously described.

### EXAMPLES

The function and advantages of these and other embodiments can be better understood from the following prophetic example. This example is intended to be illustrative in nature and is not considered to be limiting the scope of the invention.

### Prophetic Example: Customized Garment Fabrication

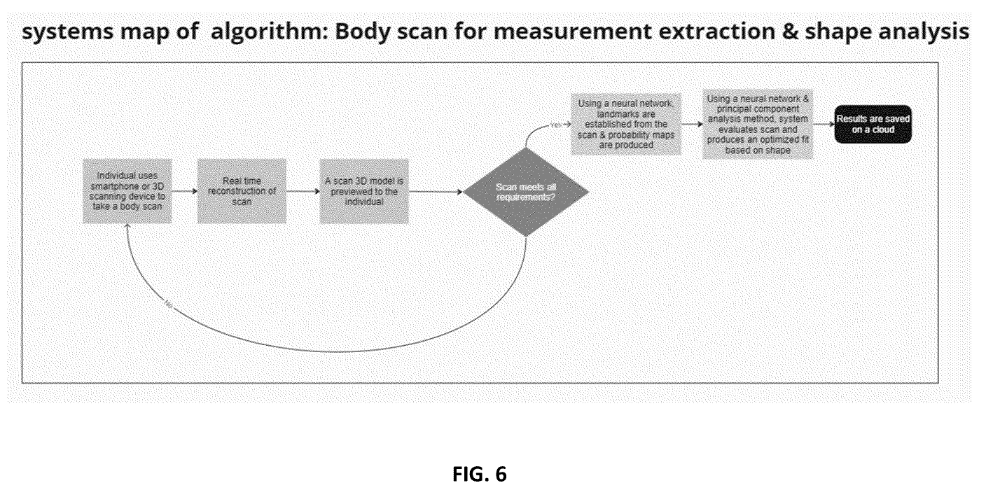

An exemplary workflow map of a method including performing a body scan, measurement extraction, and shape analysis is shown in FIG. 6. As shown in FIG. 6, an individual may use a smartphone or other camera, such as a 3D scanning device, to take a body scan. A reconstruction of the scan is produced in real time by the system software to generate a 3D model of the individual. The individual may preview the 3D model through the user interface. The individual is then asked whether the 3D model meets all requirements.

If the 3D model does not meet all requirements, the method returns to the earlier step of capturing the body scan. The individual may be asked to perform a new scan. If, instead, the 3D model does meet all requirements, parameters of the 3D model are provided to a neural network trained to establish landmarks from the 3D model and produce at least one probability map. The landmarks and probability map are provided to another neural network which utilizes the principal component analysis method to evaluate the landmarks and probabilities to produce an optimized fit of the desired garment for the individual. These results are saved to a memory storage database, in this example, a cloud-based memory storage database, associated with the individual.

### Example 1: Custom Knitting Map Generation

### Knit Map is Sized Based on Body Scan Data

One exemplary method of generating production instructions from body scan data, user preferences such as customizations, and a custom pattern is described herein. The production instructions may be in the form of a knit map or bitmap.

Knit instructions for computerized knitting machines may be represented by 2D grids known as knitting maps or bitmaps. These bitmaps generally serve as a digital representation of the pattern, where each pixel or cell corresponds to a specific stitch or machine action. Each stitch type, such as knit, purl, or modifications, such as increases, decreases, or color changes, may be encoded in the bitmap, allowing for detailed control of the knitting process.

After the user selects the type or style of garment from a library of options and completes a body scan, the user is matched with a pre-made bitmap corresponding to the selected style and the size closest to their measurements. For example, if the user chooses a tank top and their body shape and measurements are closest to a predefined/graded size small, the user will be matched with the corresponding knitting map for a predefined/graded size small tank top.

Next, rows and columns may be added to the bitmap along parameters that correspond to the different body measurements extracted from the scan. This allows the bitmap to be dynamically adjusted to make the garment larger or smaller, ensuring an optimal fit. Instead of simply stretching or compressing the bitmap uniformly, rows and columns may be added or subtracted in key areas to accommodate the unique body measurements, such as at the bust, waist, or hips. This ensures the shape of the garment follows the user's contours while maintaining the intended design.

The structure of the garment may be further manipulated by strategically altering the bitmap, where rows and columns are placed or removed to adjust the fit. This technique ensures the final knitted piece has the correct proportions and fit based on the scan data. By adding or subtracting rows in specific locations, the garment adapts to different body shapes without affecting the overall pattern or tension of the knit.

In most cases, garments may be knitted as a whole (seamless). However, in some cases, garments may be knitted in pieces and later assembled. For example, a garment pattern may include elements that correspond to selected widths of a front panel of a shirt at multiple identified locations across the face of the panel.

This method of altering bitmaps may be applied to any bitmap, whether pre-made or generated from scratch, enabling flexible and on-demand custom sizing in knitwear production.

### Knitting Map is Created Based on User Wants

The user interface may be programmed to generate a custom pattern from style and fit preferences. The user may enter a text prompt identifying a type of garment of interest, answer a questionnaire about preferences, and/or provide a reference image of the type of garment of interest. The user interface may interpret the input of preferences to generate a custom pattern.

In certain embodiments, the user interface may employ generative AI methods to interpret this input. For text prompts, a natural language processing (NLP) model like a generative pre-trained transformer (GPT), may analyze the description and identify key garment features such as type (e.g., sweater, dress), style elements (e.g., long sleeves, V-neck), and fit preferences (e.g., fitted, loose). The AI may translate this description into custom design attributes that may be used to generate a custom pattern. For reference images, a computer vision model, such as a convolutional neural network (CNN), may be employed to detect features from the image. The CNN may identify the shape, fabric texture, details like buttons or zippers, and/or construction elements like the neckline, sleeve length, and drape of the garment. The CNN may generate custom design attributes from the identified features to generate a custom pattern. In the case of a questionnaire, answers provided by the user may guide the system through specific garment preferences, such as fabric type, fit (tight, relaxed), garment length, and specific design features of preference. Custom attributes may be identified from the questionnaire responses, and a custom pattern may be generated.

Once the input is processed to generate the custom attributes, the user interface may access a comprehensive database of knitting bitmaps and instructions, that contain a wide variety of garment components, such as different sleeve types, neckline options, body shapes, and design variations. Based on the interpretation of the input, the user interface may match the garment features from the input to relevant bitmaps within the database. For instance, if the input specifies a fitted sweater with long sleeves and a round neckline, the user interface may retrieve bitmaps corresponding to a fitted body, long sleeves, and a round neckline. Each of these bitmaps may represent a part of the garment and include detailed knitting instructions for the corresponding section. The user interface may then intelligently combine these bitmaps into a cohesive knitting map that reflects the entire garment.

The knitting map may be dynamically adjusted to ensure that all parts of the garment fit together smoothly. The user interface may modify the bitmaps where necessary, taking into account the body measurements or preferences regarding fit. For example, if the user prefers a loose fit, the user interface may adjust the bitmaps to add more rows or columns in strategic places to increase the size. Similarly, body scan data may be used to ensure that the garment is customized to fit the user's exact proportions, with each section of the knitting map adapted for size, shape, and drape.

If the custom pattern suggests a more creative or unique garment design, the user interface may employ generative AI techniques such as Generative Adversarial Networks (GANs) or Variational Autoencoders (VAEs) to generate new garment features by combining or evolving existing patterns. These AI models may be employed to create novel designs by blending characteristics from different bitmaps in the database, offering a new garment style that matches the fit and style input while introducing unique design elements.

After the fit and style choices have been transformed into a design, the user interface may prepare the final knitting map (custom pattern) for production. The knitting map, which generally includes all features and adjustments for the garment, may be converted into machine-ready production instructions. These instructions may be translated into a machine-readable format, such as .dat for Stoll machines or .kpf for Shima Seiki machines, enabling the knitting machine to produce the garment automatically. The user interface may ensure that the knitting instructions are formatted correctly, taking into account the specific stitch types, yarn feed, and tension settings required for the garment.

Before final production, the system may generate a simulation of the garment to allow the user to preview how it will look when worn. This simulation may display the garment on a 3D avatar based on the body measurements, showing how the garment fits, drapes, and reacts to movement. The user may be given the option to make final adjustments to the design, such as changing the sleeve length or modifying the neckline. Once the user confirms the design, the user interface may finalize the production instructions and prepare the garment for production, ensuring a seamless process from user input to final product.

The methods described herein allow for highly customized, on-demand garments to be produced with minimal manual intervention, combining generative AI and knitting technology.

Input Converted into Knitting Map

In certain embodiments, the user may upload an existing knitting map of a garment in .bmp, .png, or .jpeg file formats to the user interface. Once uploaded, the user interface may manipulate the knitting map based on the body scan data, including shape analysis and body measurements, to ensure a proper fit.

Alternatively, the user may upload a 3D model of a garment. After the 3D model is uploaded, the 3D model may be converted into a knitting map. To do this, the 3D model may be transformed into a stitch mesh, where each polygonal facet represents a knitting stitch (e.g., quadrangular facets for plain stitches and triangular facets for shaping stitches). Shaping stitches, such as short-rows and short-columns, are useful for creating the curvature necessary for 3D knitting.

Once the stitch mesh is generated, it may be converted into a knitting map, which is a 2D grid representing the layout of stitches. The conversion process may involve arranging the rows and columns of the stitch mesh into a rectangular grid. The placement of short-rows may be controlled by a geodesic distance field, and for more complex shapes, a Laplacian-based time field may be used to place both short-rows and short-columns.

To ensure that the knitting map may be produced without issues, an optimization process may be used. The optimization process may minimize potential problems such as yarn stretching or misalignment. A graph-based algorithm may be applied to control the placement of shaping stitches, which may be used for forming non-planar, 3D shapes. This ensures the final knitting map replicates the 3D mesh accurately, while also making sure the fabric can be reliably produced on a knitting machine.

The user interface may also take practical manufacturing constraints into account, such as minimizing transfer stitches, which may lead to yarn abrasion or mis-transfer, thereby ensuring the stability and quality of the final knitted garment.

Once the 3D model has been successfully converted into a knitting map, the system may size the knitting map according to the body scan, manipulating the map based on body measurements and shape analysis as previously described.

### Example 2: Garment and Fit Simulation

Converting 2D Bitmap into a 3D Mesh

In order to simulate the fit of a garment, the 2D knitting is converted into a 3D stitch mesh. The process begins by generating the stitch mesh from the 2D knitting map, where each cell corresponds to a stitch in the final fabric. The knitting map contains predefined stitch types and knitting order, which are processed by interpreting the grid of cells as a collection of faces, either quadrilateral or triangular. The edges between neighboring cells define connections between these stitch faces. To maintain the correct order of knitting, topological sorting is applied to the rows and columns of the knitting map, ensuring that the stitches align correctly when mapped onto a 3D structure.

Next, the stitch mesh is constructed by sequentially adding faces (stitches) based on the knitting map's predefined order. During this process, care is taken to ensure manifoldness, meaning the mesh remains continuous and without gaps or overlaps. Each vertex of a new stitch is checked to determine if it can merge with existing vertices on the mesh, thereby maintaining continuity.

Once the stitch mesh is constructed, the 2D shape initially lies flat in the xy-plane. At this stage, the mesh is unrelaxed, with all stitches appearing flat. To transform this 2D mesh into a 3D structure, a deformation process is applied using the as-rigid-as-possible (ARAP) deformation technique. This technique helps the stitches retain their local geometry as much as possible while being bent or stretched into the correct 3D shape. Following this, a shape relaxation process is carried out to predict the final, physically plausible 3D shape, accounting for the fabric's stretch and elasticity properties. This allows the 2D stitches to naturally deform into the appropriate 3D configuration.

Finally, the 3D mesh is validated for knittability, ensuring that the converted structure can be produced by a knitting machine. This step involves checking that all stitch types and transitions between stitches comply with the machine's capabilities, ensuring the garment can be knitted as intended.

### Simulation of the Garment on Body

Once the knitting map is converted into a 3D mesh, the next step is to apply physical properties to both the garment and the body scan or 3D avatar to simulate how the garment will fit and behave in real-world conditions. This simulation can be conducted using existing software platforms such as CLO 3D, Marvelous Designer, Browzwear VStitcher, Autodesk Maya (with plugins like nCloth for fabric simulation), Blender (which includes physics and cloth simulation tools), or Ansys for more detailed physical simulations.

Alternatively, a custom solution for garment simulation may be created using programming languages and libraries. For instance, Python can be used with libraries like PyBullet (a physics engine), NumPy (for numerical calculations), and PyOpenGL (for rendering). Another option is to use C++ with the Bullet Physics Engine for fast real-time physics, along with OpenGL or Vulkan for rendering. For more interactive simulations, platforms like Unity (C#) or Unreal Engine (C++) offer built-in physics engines, such as Unity's Cloth Physics and Unreal's Chaos Cloth Simulation.

### Applying Physics to the Garment

The custom pattern may be specific to the type of fabric to be used for the garment. In some embodiments, the production instructions may be adjusted responsive to a selection of one or more property of the fabric to be used for production of the garment, from density, stretch, drape, stiffness, elasticity, and friction.

In both commercial software and custom-built solutions, the user interface may be programmed to assign accurate fabric properties to the garment model. These properties reflect the variability of materials across different sections of the garment and include:
Density: The mass per unit area or volume of the fabric, which influences how the fabric behaves under its own weight.
Stretch: The fabric's ability to stretch under tension, in both the warp and weft directions, ensuring the garment can move with the body and fit properly.
Drape: How the fabric hangs or falls under its own weight, affecting the visual appearance and movement of the garment.
Stiffness: The fabric's resistance to bending, which affects how it holds its shape and structure.
Elasticity: The fabric's ability to return to its original shape after being stretched or deformed, crucial for maintaining the garment's fit after wear.
Friction: How the fabric interacts with other surfaces, such as skin or other parts of the garment, impacting comfort and movement.

Simulating fabric physics can be done using a mass-spring system, in which each vertex of the garment mesh acts as a point mass, and the edges between them act as springs. These springs control the stretch and drape of the fabric, while additional springs manage bending and shearing behavior. In more advanced simulations, finite element methods (FEM) can be used to divide the fabric into small elements and calculate deformation under external forces like gravity or movement.

### Applying Physics to the 3D Avatar (Soft Body Simulation)

To create a realistic fit simulation, the body scan or 3D avatar (representation of the body scan) should behave as a soft body, rather than a rigid structure. This allows the simulation to account for how the body's soft tissue (such as skin, muscles, and fat) deforms under the pressure and weight of the garment, providing a more realistic fit.

In both existing software and custom-built systems, soft body physics can be applied to the avatar. Using soft body simulation techniques may ensure that the displayed body reacts dynamically to pressure and movement applied by the garment, simulating real-life interactions between the body and fabric. Parameters include:

Soft Body Dynamics: This feature allows the body model to deform under external forces, such as pressure from tight-fitting clothing. The simulation adjusts how different parts of the body compress and respond to the garment's tension.

Elasticity and Deformation: Just as fabric properties like elasticity are critical, the body model also requires similar characteristics to reflect how muscles, fat, and skin behave under the garment. This allows the simulation to capture realistic body movement and fit.

Collision Detection: Ensures that the garment does not intersect with the body, but instead reacts naturally as it drapes and moves around the contours of the body.

In a custom solution, physics engines like PyBullet, Unity, or Unreal Engine support soft body dynamics and can be used to model body deformations in response to the garment. The soft body physics simulate how the garment applies pressure, how the body tissue deforms under the fabric, and how both the garment and body react to external forces like gravity and movement.

### Integrating Garment and Soft Body Simulation

In both commercial software and custom-built solutions, the garment and the body model are simulated together to create a fully interactive fit experience. As the soft body model responds to the garment's pressure and the garment responds to the body's shape, the simulation dynamically adjusts to changes in posture, movement, and fabric behavior.

The soft body avatar interacts with the fabric, accounting for stretch, compression, and overall fit. The 3D mesh of the garment deforms based on the body's movement and the fabric's properties, creating a realistic simulation of how the garment will behave under various conditions. External forces like gravity and body movement are applied to simulate how the fabric and body interact in dynamic scenarios.

### Rendering and Analysis

Once the physics and soft body simulations are complete, the results can be rendered in real-time to visualize how the garment fits and behaves on the body. This allows designers to analyze the fit, identify problem areas (such as excessive tightness or sagging), and make necessary adjustments before moving to production. Additionally, the user interface may employ tools like pressure maps and tension visualizations to highlight areas where the fabric exerts pressure on the body, helping assess both fit and comfort.

By combining fabric and soft body physics, this approach enables highly realistic garment simulations that provide valuable insights into both design and fit, reducing the need for physical prototypes and speeding up the development process. Whether using commercial software or developing a custom solution, these simulations ensure the final garment performs as expected.

### Example 3: Developing Knitting Instructions

After the user accepts the custom pattern visualized during the simulation, a final knitting map is generated. That knitting map is then converted into machine instructions. This process can be done manually using existing knitting machine software such as Stoll M1 Plus or Shima Seiki's SDS-ONE APEX. The user may input the stitch instructions and export them as a .dat or .kpf file. However, an automatic workflow can be implemented to streamline this process, especially when dealing with multiple designs or custom production.

First, the bitmap representing the knitting map is interpreted as a grid of stitches, where each pixel corresponds to a specific stitch action, such as knit, purl, increase, or decrease. This is achieved by using image processing libraries to read the pixel data and map it to stitch instructions based on predefined color-to-stitch mappings. The next step involves converting these stitch instructions into a format that the knitting machine can understand, such as a .dat or .kpf file. This can be done by writing custom scripts that take the interpreted stitch data and format it according to the machine's requirements, ensuring the knitting instructions match the machine's stitch capabilities.

For scalability, the process can be automated to handle multiple bitmap files simultaneously. A batch processing system can convert several bitmap files into machine-ready instructions in one go, reducing manual effort and making production more efficient. Before sending the instructions to the machine, a validation may be performed. During the validation, the system may simulate the knitting process and check for any errors, such as incompatible stitch types or stitch counts that the machine cannot handle, ensuring that the final output is viable for knitting.

Once the instructions are validated, they are transferred to the knitting machine. This step can also be automated, with scripts automatically sending the .dat or .kpf files to the machine via FTP or a networked folder. By creating this automated workflow, the process of converting a bitmap to machine-ready knitting instructions is streamlined, making it easier to manage large-scale or on-demand garment production.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A method of producing a customized garment for a subject, comprising:
acquiring a plurality of physical parameters from the subject;
providing the plurality of physical parameters to an artificial neural network trained to extract measurements and define a shape analysis of the subject to produce a digital body;
responsive to the extracted measurements and shape analysis, producing a custom pattern;
displaying the custom pattern on the digital body;
generating production instructions from the custom pattern; and
directing the production instructions to a knitting machine programmed to produce at least a portion of the customized garment in accordance with the production instructions.

2. The method of claim 1, wherein the plurality of physical parameters are acquired through a body scan of the subject.

3. The method of claim 1, further comprising acquiring a garment type selection from the subject and producing the custom pattern responsive to the extracted measurements, shape analysis, and the garment type selection.

4. The method of claim 1, further comprising:
providing at least two customization options associated with the custom pattern;
acquiring a selection of at least one customization option;
responsive to the selection of the at least one customization option, producing an updated custom pattern;
displaying the updated custom pattern on the digital body; and
generating the production instructions from the updated custom pattern.

5. The method of claim 1, further comprising generating post-knitting instructions from the custom pattern and directing the post-knitting instructions to a post-knitting subsystem programmed to produce a remaining portion of the customized garment in accordance with the post-knitting instructions.

6. The method of claim 1, further comprising displaying the digital body, and responsive to a rejection of the digital body, acquiring new physical parameters of the subject.

7. The method of claim 1, further comprising storing the digital body and the custom pattern on a memory storage unit.

8. The method of claim 7, further comprising storing a plurality of digital bodies from a plurality of users and a plurality of custom patterns on a database.

9. The method of claim 8, further comprising providing at least one recommended customization option associated with the custom pattern, the at least one recommended customization option generated responsive to the plurality of custom patterns stored on the database, wherein the at least one recommended customization option is associated with at least one similar digital body from another subject.

10. The method of claim 1, comprising directing the production instructions to an order management system operably connected to a plurality of knitting machines, the order management system programmed to direct the production instructions to an optimal knitting machine responsive to criteria selected from location of the knitting machine, capabilities of the knitting machine, and availability of materials associated with the knitting machine.

11. The method of claim 1, wherein the production instructions include instructions to incorporate a unique identifier in the at least a portion of the customized garment.

12. A system for producing a customized garment for a subject, comprising:
a body scanner configured to capture a digital representation of a subject;
a computing unit running a user interface operably connectable to the body scanner, the user interface configured to:
extract measurements and generate a shape analysis of the subject from the digital representation of the subject,
display a digital body produced from the extracted measurements and shape analysis,
produce a custom pattern from the extracted measurements and shape analysis,
display the custom pattern on the digital body, and
generate production instructions from the custom pattern; and
a production subsystem operably connectable to the user interface configured to produce at least a portion of the customized garment in accordance with the production instructions.

13. The system of claim 12, wherein the body scanner is a camera on a smart phone.

14. The system of claim 12, wherein the computing unit is a smart phone or computer.

15. The system of claim 12, wherein the production subsystem comprises a knitting machine.

16. The system of claim 15, wherein the production subsystem further comprises a thermoform and/or a 3D printer.

17. The system of claim 12, wherein the computing unit is operably connected to a memory storage device programmed to store the digital body and the custom pattern.

18. The system of claim 17, wherein the memory storage device is a cloud-based memory storage.

19. The system of claim 12, wherein the computing unit is operably connected to a database programmed to store a plurality of digital bodies from a plurality of users and a plurality of custom patterns.

20. The system of claim 19, wherein the user interface is configured to provide at least one recommended customization option responsive to the plurality of custom patterns.

21. The system of claim 12, comprising a network of production subsystems and an order management system operably connectable to the computing unit, the order management system programmed to direct the production instructions to an optimal production subsystem within the network of production subsystems responsive to criteria selected from location of the production subsystem, capabilities of the production subsystem, and availability of materials associated with the production subsystem.

22. A method of facilitating customized garment production for a subject, comprising providing a user interface configured to:
extract measurements and generate a shape analysis of the subject from a digital representation of the subject,
display a digital body produced from the extracted measurements and shape analysis,
produce a custom pattern from the extracted measurements and shape analysis,
display the custom pattern on the digital body, and
generate production instructions from the custom pattern.

23. The method of claim 22, further comprising providing a knitting machine operably connectable to the user interface configured to produce at least a portion of the customized garment in accordance with the production instructions.

24. A system for producing a customized garment for a subject, comprising:
an order management system operably connectable to a computing unit running a user interface, the user interface configured to: extract measurements and generate a shape analysis of the subject from a digital representation of the subject captured from a body scanner, produce a custom pattern from the extracted measurements and shape analysis, and generate production instructions from the custom pattern; and
a network of production subsystems operably connectable to the order management system configured to produce at least a portion of the customized garment in accordance with the production instructions,
the order management system programmed to direct the production instructions to an optimal production subsystem within the network of production subsystems responsive to criteria selected from location of the production subsystem, capabilities of the production subsystem, and availability of materials associated with the production subsystem.
